(19) United States
(12) Patent Application Publication
(10) Pub. No.: US 2025/0379237 A1
(43) Pub. Date: Dec. 11, 2025

(54) ELECTROCHEMICAL CELLS WITH SUPPORT FIBER MATS AND MANUFACTURING METHODS THEREOF

(71) Applicant: Bloom Energy Corporation, San Jose, CA (US)

(72) Inventors: Travis A. SCHMAUSS, Burlingame, CA (US); Keji PAN, Pleasanton, CA (US); Emad EL BATAWI, Aurora, CO (US)

(21) Appl. No.: 19/227,700

(22) Filed: Jun. 4, 2025

Related U.S. Application Data
(60) Provisional application No. 63/656,388, filed on Jun. 5, 2024.

(51) Int. Cl. H01M 4/86; C25B 9/77; C25B 11/031; C25B 11/067; C25B 13/07; H01M 4/88; H01M 8/12

(52) U.S. Cl. CPC H01M 4/8621; C25B 9/77; C25B 11/031; C25B 11/067; C25B 13/07; H01M 4/8657; H01M 4/8803; H01M 4/8885; H01M 2004/8684; H01M 2008/1293

(57) ABSTRACT

An electrochemical cell includes an anode support, an anode electrode disposed on the anode support, an electrolyte layer disposed on the anode electrode, and a cathode electrode disposed on the electrolyte layer. The anode support includes a mat of ceramic support fibers and a cermet matrix including a nickel phase and a ceramic phase embedded in the mat.

### FIELD

Aspects of the present disclosure relate generally to electrochemical cells, and particularly to electrochemical cells including support fiber mats.

### BACKGROUND

A typical solid oxide fuel cell includes a ceramic electrolyte layer disposed between an anode electrode and a cathode electrode. In general, thin electrolyte layers are desired to provide high ionic conductivity. However, thin electrolyte layers may be damaged during stack manufacturing, reduction-oxidation cycling, and/or thermal cycling.

### SUMMARY

According to various embodiments, an electrochemical cell includes an anode support, an anode electrode disposed on the anode support, an electrolyte layer disposed on the anode electrode, and a cathode electrode disposed on the electrolyte layer. The anode support includes a mat of ceramic support fibers and a cermet matrix including a nickel phase and a ceramic phase embedded in the mat.

According to various embodiments, a method of forming an electrochemical cell comprises providing a mat comprising electrospun support fibers; embedding a cermet matrix material in the mat to form an anode support; forming an anode electrode over the anode support; forming a ceramic electrolyte over the anode electrode; and forming a cathode electrode over the ceramic electrolyte.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a perspective view of an electrochemical stack, according to various embodiments of the present disclosure, and FIG. 1B is cross-sectional view of a portion of the stack of FIG. 1A.

FIG. 2A is an exploded perspective view of an anode, according to various embodiments of the present disclosure, and FIG. 2B is a cross-sectional view of a portion of the anode of FIG. 2A.

FIG. 3 is a schematic perspective view of an electrospinning apparatus that may be used to form a mat of electrospun support fibers of the anode of FIGS. 2A and 2B.

FIGS. 4A and 4B are schematic side cross-sectional views of tape casting and slot die coating steps, respectively, which may be used to form a matrix of the anode of FIGS. 2A and 2B.

FIG. 5 is a cross-sectional view of a portion of an anode supported electrochemical cell, according to various embodiments of the present disclosure.

FIG. 6 is a cross-sectional view of a portion of a co-supported electrochemical cell, according to various embodiments of the present disclosure.

### DETAILED DESCRIPTION

The present disclosure is described with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and fully conveys the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be a hydrogen (H₂) or a hydrocarbon fuel, such as methane, natural gas, pentane, ethanol, or methanol. The fuel cell, operating at a typical temperature between 750° C. and 950° C., enables the transport of negatively charged oxygen ions from the cathode flow stream to the anode flow stream, where the oxygen ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a solid oxide electrolyzer system, water (e.g., steam) is separated into hydrogen and oxygen by applying a voltage across the electrolyzer cells.

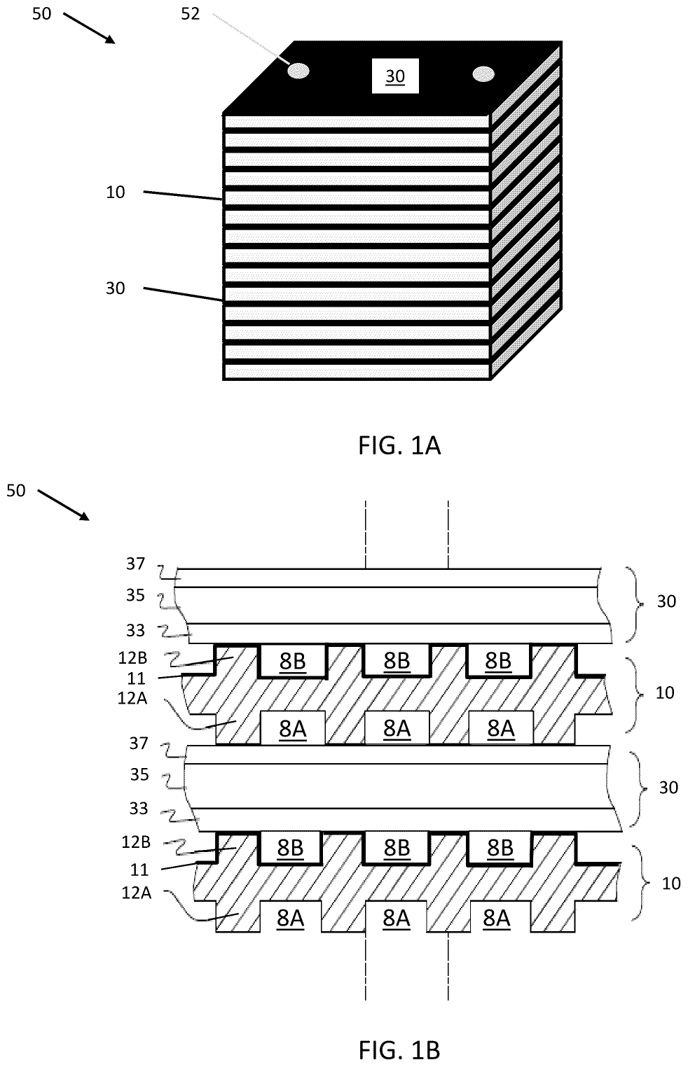

FIG. 1A is a perspective view of an electrochemical cell stack 50, and FIG. 1B is a cross-sectional view of a portion of the stack 50, according to various embodiments of the present disclosure. In the embodiments below, the stack 50 is described as being operated as a solid oxide fuel cell (SOFC) stack 50. However, it should be noted that the stack 50 could be operated as an electrolyzer (e.g., a solid oxide electrolyzer cell (SOEC) stack). Referring to FIGS. 1A and 1B, the stack 50 includes electrochemical cells 30, such as fuel cells (e.g., SOFCs) or electrolyzer cells (e.g., SOECs), separated by interconnects 10. In the embodiments below, the electrochemical cells 30 are described as being fuel cells. Referring to FIG. 1B, each fuel cell 30 comprises a cathode electrode 33, a solid oxide electrolyte 35, and an anode electrode 37. However, it should be noted that the electrochemical cells 30 may alternatively comprise electrolyzer cells which include a solid oxide electrolyte 35 located between an air electrode 33 and a fuel electrode 37.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., may also be used. The cathode electrode 33 may also contain a ceramic phase similar to the anode electrode 37. The electrodes and the electrolyte may each comprise one or more sublayers of one or more of the above-described materials.

Fuel cell stacks 50 are frequently built from a multiplicity of SOFC's 30 in the form of planar elements, tubes, or other geometries. Although the fuel cell stack in FIG. 1A is vertically oriented, fuel cell stacks may be oriented horizontally or in any other direction. Fuel and air may be provided to the electrochemically active surfaces, which can be large. For example, fuel may be provided through fuel holes (e.g., fuel riser openings) 52 formed in each interconnect 10. The fuel holes 52 may be aligned to form fuel conduits that extend through the stack 50.

Each interconnect 10 electrically connects adjacent fuel cells 30 in the stack 50. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent iron, optionally 1 or less weight percent yttrium and balance chromium alloy and may electrically connect the anode or fuel-side of one fuel cell 30 to the cathode or air side of an adjacent fuel cell 30. An electrically conductive contact layer, such as a nickel layer or mesh, may be provided between anode electrodes 37 and a fuel side of each interconnect 10. An electrically conductive protective layer 11, such as lanthanum strontium manganate and/or manganese cobalt spinel, may be provided on at least an air side of each interconnect 10.

Electrochemical cells, such as SOFCs and SOECs, are typically supported in order to increase mechanical stability and reliability. For example, supported cells include electrode-supported cells, electrolyte-supported cells, and co-supported cells. Electrolyte-supported cells include a relatively thick electrolyte layer upon which relatively thin electrodes are formed. Electrode supported cells include a relatively thick supporting electrode (e.g., anode) to provide structural support, and co-supported cells may include a relatively thick supporting electrode and a relatively thick electrolyte.

Electrolyte-supported cells offer numerous advantages including improved sealing resulting from a dense electrolyte perimeter and reduction stability by having a thin anode. However, electrolyte-supported cells often exhibit higher area specific resistance (e.g., Ohmic resistance) values than electrode-supported cells because the electrolyte typically exhibits lower bulk electrical conductivity than the anode or cathode materials. For example, in electrolyte-supported solid oxide fuel cells, the ohmic resistance of the electrolyte layer may be the largest contributor to the total area specific resistance of the cell at typical operating temperatures (e.g., at about 800 to 850° C.).

Electrode-supported SOFCs and SOECs are typically produced by co-sintering a support electrode material and a coating of electrolyte material. Electrode-supported cells include anode-supported cells having a relatively thick anode and cathode-supported cells having a relatively thick cathode. Cathode-supported cells have the potential to be lightweight and lower in cost than anode-supported cells. However, processing of cathode-supported cells is difficult because the co-firing of most cathode materials in contact with an electrolyte produces insulating intermediate compounds.

The processing of anode-supported cells is comparatively simple because sintering temperatures in excess of 1300° C. can be used to achieve dense electrolytes. However, anode-supported cells may suffer from redox instability, affecting the operational reliability of the cell when the anode is exposed to changing oxygen partial pressures. Redox instability is caused by the volumetric expansion of Ni to NiO within the anode, which may not be fully accommodated by the open pore space. As a result, cracks may form in the anode that may decrease steady-state performance. Severe cracks can also extend to the electrolyte, reducing Nernstian voltage.

In addition, electrode-supported cells may exhibit cambering during fabrication due to a CTE mismatch between the anode and the electrolyte, which may complicate manufacturing and/or reduce cell-to-interconnect contact. For example, a shrinkage mismatch during sintering may result in camber between the electrolyte, which may have a high green density, and the anode layers, which may have a low green density. As result, compressive stress may be applied to the electrolyte. After sintering, the camber may be further exacerbated as the cell cools.

Accordingly, various embodiments provide electrochemical cells that include an anode support including a mat of ceramic support fibers with an embedded cermet matrix. Such cells resist cambering and provide high performance and reliability.

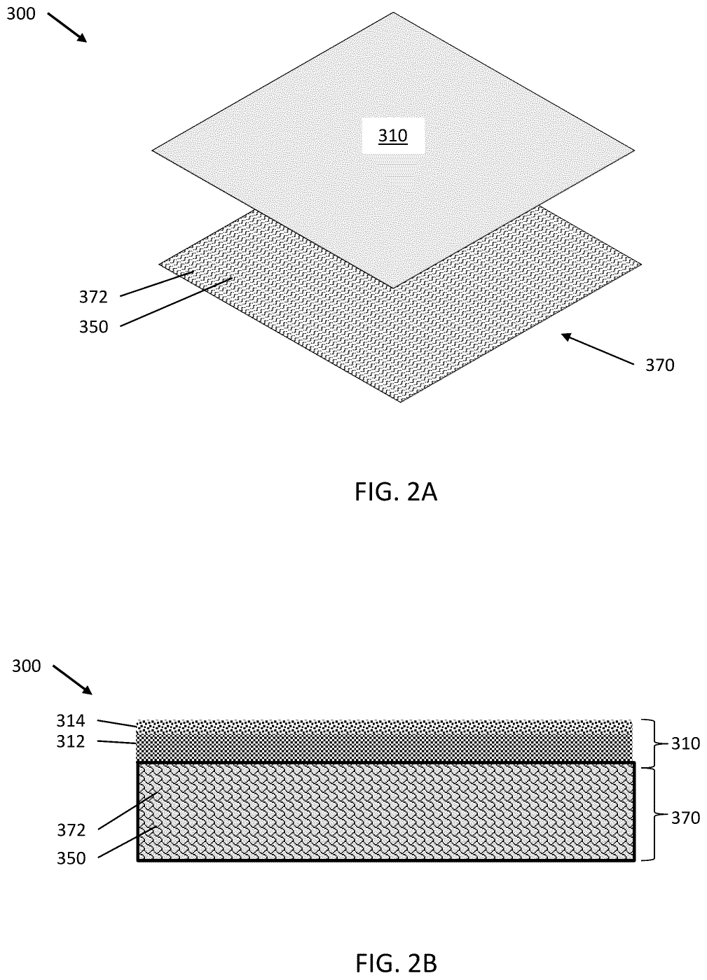

FIG. 2A is an exploded perspective view of an anode 300, according to various embodiments of the present disclosure, and FIG. 2B is a cross-sectional view of a portion of the anode 300 of FIG. 2A.

Referring to FIGS. 2A and 2B, the anode 300 may include an anode electrode 310 disposed on an anode support 370. The anode electrode 310 may include a cermet material containing a metal phase (e.g., a nickel containing phase), and an ionically conductive ceramic phase, such as a stabilized zirconia (e.g., scandia stabilized zirconia (SSZ) or yttria stabilized zirconia (YSZ)) or a doped ceria. The anode electrode 310 may be a single or multi-layer structure disposed on the anode support 370. For example, the anode electrode 310 may include a first functionally graded anode (FGA) layer 312 and a second FGA layer 314 located over the first FGA layer 312. The first FGA layer 312 may include a lower ratio of the nickel containing phase to the ionically conductive phase than the second FGA layer 314.

The anode support 370 may include a mat of ceramic support fibers 372 containing (e.g., impregnated with) an electrically conductive matrix 350. The support fibers in the mat 372 may be formed of a ceramic material, such as a stabilized zirconia material, such as yttria stabilized zirconia (YSZ), scandia stabilized zirconia (SSZ), or yttria-scandia stabilized zirconia (YSSZ), and/or a doped ceria material, such as gadolinia, yttria and/or samaria doped ceria. The ceramic material may be optionally blended with alumina, such as 2 to 5 mol % alumina. For example, the YSZ may comprise 3 to 4 mol % yttria stabilized zirconia to provide increased strength. Alternatively, the fibers may comprise any suitable YSZ, such as 3 to 10 mol % yttria stabilized zirconia. In one embodiment, the YSZ may be blended with 2 to 5 mol % alumina. In one embodiment, the support fibers in the mat 372 have no free metal phase, such as a free nickel phase, and have a nickel content of less than about 1 mol %, such as less than 0.5 mol %, less than 0.25 mol %, less than 0.1 mol %, such as 0 to 0.01 mol %. In some embodiments, the support fibers in the mat 372 may include no nickel, or only a trace amount of nickel diffused from the matrix 350.

The mat of support fibers 372 may be formed by an electrospinning process. For example, an electric field may be used to direct a charged precursor fluid down a potential gradient to form high aspect ratio polymer fibers. The polymer fibers can be loaded with ceramic material precursors, such as Zr and Y, and optionally Al precursors.

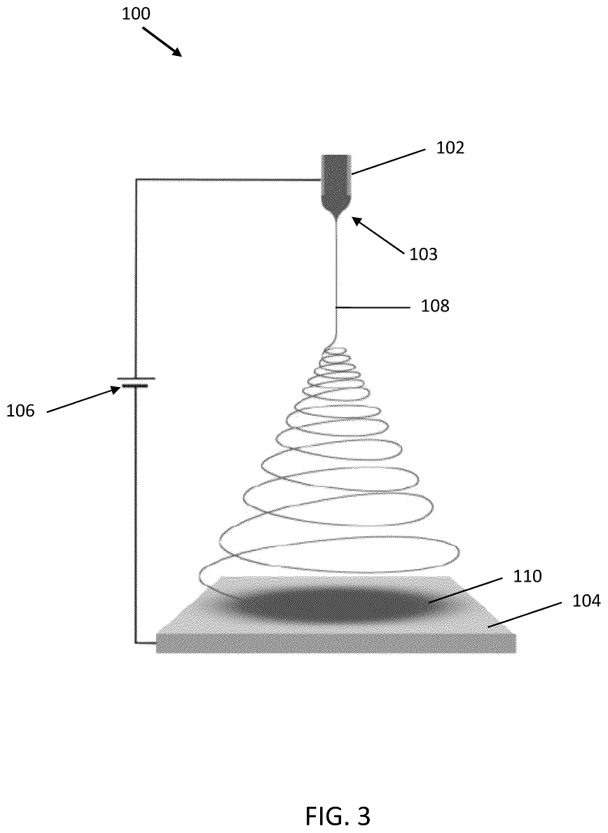

FIG. 3 illustrates an electrospinning apparatus 100. In one embodiment, the electrospinning apparatus 100 includes a spinneret 102 electrically connected to a counter electrode 104 via a high voltage supply 106. The spinneret includes a nozzle 103. A viscous precursor fluid solution or suspension is pumped into the nozzle 103, and an electric field generated by the high voltage supply 106 promotes the fluid to overcome the surface tension of the droplet at the nozzle 103 tip of the spinneret 102, and the droplet forms a Taylor cone. The viscosity of the fluid prevents the formation of separate droplets, allowing a single fiber jet 108 to be drawn from the fluid. Then, the jet 108 shrinks in diameter to form micro and/or nanofibers that dry and get collected on a carrier material located over the counter electrode 104. The electrospinning process can be divided into four stages: jet 108 initiation stage, rectilinear jet 108 formation stage, bending instability stage and fiber collection stage. During the bending instability stage, the fluid viscosity can no longer stabilize perturbations and whipping occurs. At this point the jet 108 starts whipping in a circular motion, with each consecutive circle larger than the previous one. It is believed that fiber thinning mostly happens in this stage. The whipping jet 108 reaches a carrier material located over the counter electrode 104 and deposits green-state micro and/or nanofibers 110. The spun green-state micro and/or nanofibers 110 comprise hybrid organic-inorganic fibers located on a carrier material.

For 3 mol % YSZ ceramic fibers, the precursor fluid may comprise a metal alkoxide precursor and polymer precursor solution. For example, the solution may include zirconium n-propoxide and yttrium acetate in an organic solvent, such as n-propanol, mixed with a polymer, such as polyvinyl pyrrolidone. The carrier material located over the counter electrode 104 may comprise an organic material, such as paper or a polymer material, such as biaxially-oriented polyethylene terephthalate (i.e., Mylar) or another polymer material.

In an alternative embodiment, the micro and/or nanofibers 110 may be deposited on a continuously moving web carrier material that is moving through the electrospinning apparatus 100 over the counter electrode 104 in a reel-to-reel process. The web carrier may comprise a roll of polymer material that moves horizontally above the counter electrode 104.

In another alternative embodiment, the electrospinning apparatus may comprise a Nanospider™ electrospinning apparatus available from Elmarco S.R.O. This apparatus includes an electrospinning electrode in the shape of a thin wire and a head to apply a polymer containing solution along the entire length of the wire. Nanofibers are then formed from a thin layer of polymer on the electrode under the influence of a strong electric field.

In some embodiments, the micro or nanofibers 110 may have an average diameter ranging from about 250 nm to about 2,000 nm, such as from about 450 nm to about 1,700 nm, or from about 500 nm to about 1,500 nm.

The micro or nanofibers 110 are removed from the electrospinning device 100 and located on the carrier material (e.g., carrier sheet or carrier web) to form an unwoven mat (e.g., a tangled “nest”) of randomly oriented support fibers 372. The mat of support fibers 372 may be compacted, for example by roll compaction or another compaction method, to planarize the mat of support fibers 372 and/or provide a desired thickness and/or porosity to the mat.

In one embodiment, the mat of support fibers 372 may be heated to burn out the organic (e.g., polymer) components and to convert the green-state micro or nanofibers 110 to crystalline ceramic (e.g., YSZ or Al-YSZ) fibers having a desired ceramic structural phase (e.g., tetragonal phase YSZ). Alternatively, the burn out of the organic components may be carried out during a subsequent firing of the anode 300 including the mat of support fibers 372. In some embodiments, the mat of support fibers 372 has a thickness of 50 to 500 μm, such as a 75 to 150 μm, including 100 to 120 μm.

The mat of support fibers 372 may be impregnated with an electrically conductive matrix material to form the matrix 350. The matrix 350 may be formed of a cermet material having a metal phase and a ceramic phase. For example, the matrix 350 may include a nickel-containing metal phase and a ceramic phase. The nickel containing phase may include nickel and/or nickel alloys and may optionally include other additional metals. The ceramic phase may comprise a stabilized zirconia, such as yttria and/or scandia stabilized zirconia and/or a doped ceria, such as gadolinia, yttria and/or samaria doped ceria. In some embodiments, the matrix 350 may preferably comprise Ni-YSZ, such as nickel doped 3 to 4 molar YSZ (Ni-3-4YSZ). Alternatively, the ceramic phase may comprise any suitable YSZ, such as 3 to 10 mol % yttria stabilized zirconia. In one embodiment, the matrix material also includes a sacrificial organic (e.g., polymer) pore former material.

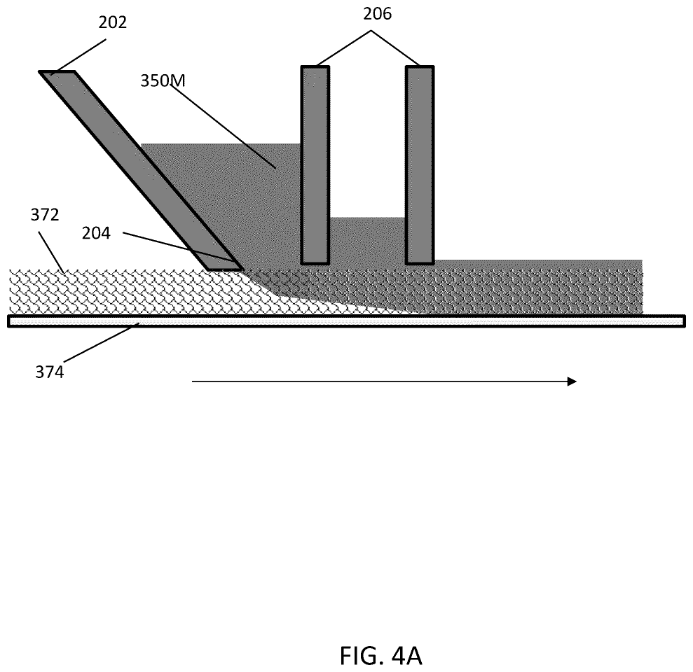

The matrix material may be applied to the mat of support fibers 372 using any suitable process, such as a tape casting or a slot die coating process. The tape casting process is shown in FIG. 4A. The mat of support fibers 372 is located on the carrier material (e.g., a polymer or paper substrate or web) 374. The matrix material 350M comprises a fluid, such as a slurry or ink comprising the powders of the cermet precursor materials (e.g., nickel oxide and YSZ powders), an optional organic binder, and optional sacrificial organic pore former particles in a carrier liquid. The matrix material 350M is dispensed from a reservoir 202 through a slot or nozzle 204 onto the mat of support fibers 372. The dispensed matrix material 350M is planarized into a shape of a tape or film over the mat of support fibers 372 by one or more doctor blades 206. The matrix precursor material 350M fills the spaces in the mat of support fibers 372 similar to how cement fills spaces in a rebar. In one embodiment, the film of matrix material 350M may be thicker than the mat of support fibers 372 (e.g., 5 to 50 microns thicker) such that the slot or nozzle 204 and the doctor blade(s) 206 make no or minimal contact with the top of the mat of support fibers 372 during the relative lateral movement of the reservoir 202 and doctor blade(s) 206, and the mat of support fibers 372 on the carrier material 374.

The slot die process is shown in FIG. 4B. The matrix material 350M is dispensed from a slot die 252 through a slot 254 onto the mat of support fibers 372 during the relative lateral movement of the reservoir slot die 252 and the mat of support fibers 372 on the carrier material 374. The matrix precursor material 350M fills the spaces in the mat of support fibers 372 located on the carrier material 374.

The mat of support fibers 372 filled with the matrix material 350M may be heated at an elevated temperature to evaporate the liquid of the matrix material 350M and to optionally burn off the organic (e.g., polymer) materials. The heating converts the green hybrid fibers to ceramic (e.g., YSZ or Al-YSZ) support fibers in the mat 372, forms the solid cermet matrix material 350 embedded in the mat of support fibers 372, and volatizes the optional pore former material in the matrix material 350M to leave pores in the solid cermet matrix 350. The heating may also volatize the paper or polymer carrier material 374 to form a free standing mat of support fibers 372 filled with the cermet matrix 350. Alternatively, the heating step may be omitted at this point in the process, and the burn off may be carried out during a subsequent firing step.

The mat of support fibers 372 filled with the matrix 350 may be cut to size to form the anode support 370 shown in FIGS. 2A and 2B.

The anode electrode 310 is then deposited on the anode support 370. As discussed above, the anode electrode 310 may include the first FGA layer 312 and the second FGA layer 314. The first and second FGA layers may be deposited on the anode support 370 using any suitable deposition method, such as a screen printing method in which an ink comprising the cermet precursors of the FGA layers is sequentially deposited on the anode support 370.

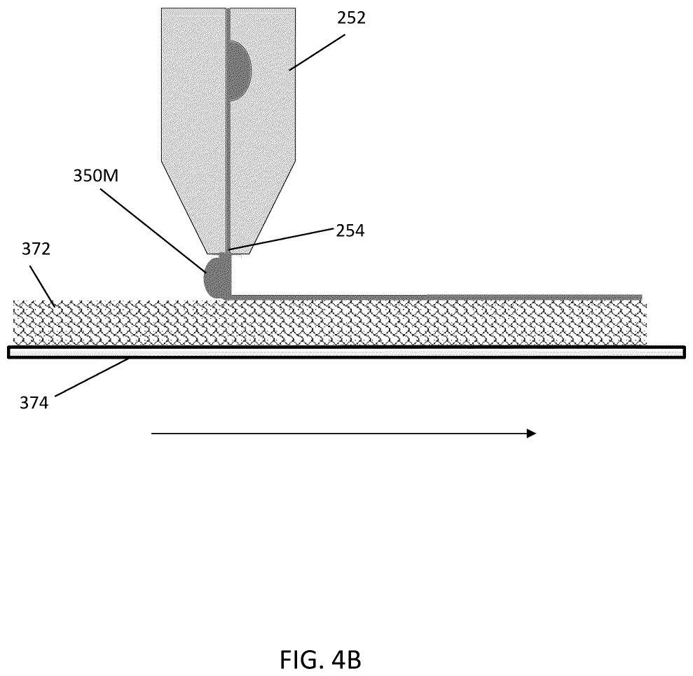

FIG. 5 is a vertical cross-sectional view of a portion of an anode supported fuel cell 400, according to various embodiments of the present disclosure. Referring to FIG. 5, the cell 400 may include the anode 300 shown in FIGS. 2A and 2B, an electrolyte layer 410, an optional barrier layer 412, and a cathode electrode 420.

The electrolyte layer 410 may be formed of an ionically conductive ceramic material, such as a stabilized zirconia material or a doped ceria material. For example, the electrolyte layer 410 may include scandia stabilized zirconia (SSZ), yttria stabilized zirconia (YSZ), yttria-ceria-stabilized zirconia (YCSZ), ytterbia-ceria-scandia-stabilized zirconia (YbCSSZ), or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference.

The optional barrier layer 412 may comprise a doped ceria layer, such as a gadolinia or scandia doped ceria (GDC or SDC) layer. The barrier layer 412 may be configured to prevent diffusion of cathode materials into the electrolyte layer 410.

The electrolyte layer 410 may be deposited on the anode electrode 300 using any suitable deposition method, such as a screen printing method in which an ink comprising the ceramic material of the electrolyte layer is deposited on the anode electrode 310.

The optional barrier layer 412 may be deposited on the electrolyte layer 410 using any suitable deposition method, such as a screen printing method in which an ink comprising the ceramic material of the barrier layer is deposited on the electrolyte layer 410.

The assembly of the anode support 370, the anode electrode 310, the electrolyte layer 410, and the optional barrier layer 412 may be fired at any suitable temperature to remove the liquid and organic (e.g., binder) components of the electrolyte layer and the barrier layer inks. The firing temperature may be between 1250 degrees Celsius and 1450 degrees Celsius, such as between 1300 degrees Celsius and 1400 degrees Celsius. The assembly may be pressed together during the firing to sinter the layers of the assembly during the firing (i.e., sintering) step.

If the anode support 370 and/or the anode electrode 310 have not been subjected to a burn off or another heating step prior to the firing step, then the firing step also converts the green-state hybrid fibers to ceramic (e.g., YSZ or Al-YSZ) support fibers in the mat 372, converts the green-state matrix material 350M to a solid cermet matrix material 350 embedded in the mat of support fibers 372, and volatizes the optional pore former material in the matrix material 350M to leave pores in the solid cermet matrix 350. The firing may also burn off the organic (e.g., binder) material and volatize any remaining liquid in the anode electrode 310 to form the cermet first and second FGA layers 312, 314 in the anode electrode 310. The firing may also volatize the paper or polymer carrier material 374 to form a free standing mat of support fibers 372 filled with the cermet matrix 350 which supports the anode electrode 310 and the electrolyte layer 410.

Subsequently, the cathode electrode 420 may be deposited over the electrolyte layer 410 (e.g., on the barrier layer 412, (if present)). The cathode electrode 420 may be a single or multi-layer electrode structure. For example, as shown in FIG. 5, the cathode electrode 420 may include a cathode functional layer 422 and a cathode contact layer 424. The cathode functional layer 422 may include a cathode catalyst, such as lanthanum strontium manganate, lanthanum strontium cobaltite, lanthanum strontium cobalt ferrite or lanthanum nickel ferrite, and the cathode contact layer 424 may include an electrically conductive material, such as lanthanum strontium manganate configured to reduce electrical resistance between the cathode electrode 420 and an adjacent component, such as an interconnect.

In particular, a cathode functional layer 422 and a cathode contact layer 424 may be sequentially deposited on the barrier layer 412 using any suitable method, such as screen printing. The stack of all layers shown in FIG. 5 may be fired (e.g., sintered) at a relatively lower temperature compared to the first firing step to form a solid oxide electrochemical cell 400. For example, the firing temperature may range from 1000 to 1200 degrees Celsius, such as from 1050 to 1150 degrees Celsius.

The anode support 370 may have a thickness ranging from about 50 μm to about 400 μm, such as from about 75 μm to about 300 μm, or from about 100 μm to about 200 μm. The electrolyte layer 410 may have a thickness ranging from about 2 μm to about 10 μm, such as from about 4 μm to about 8 μm, or from about 5 μm to about 7 μm. Accordingly, the relatively thick anode support 370 may support the relatively thin electrolyte layer 410 which is thinner than the anode support 370.

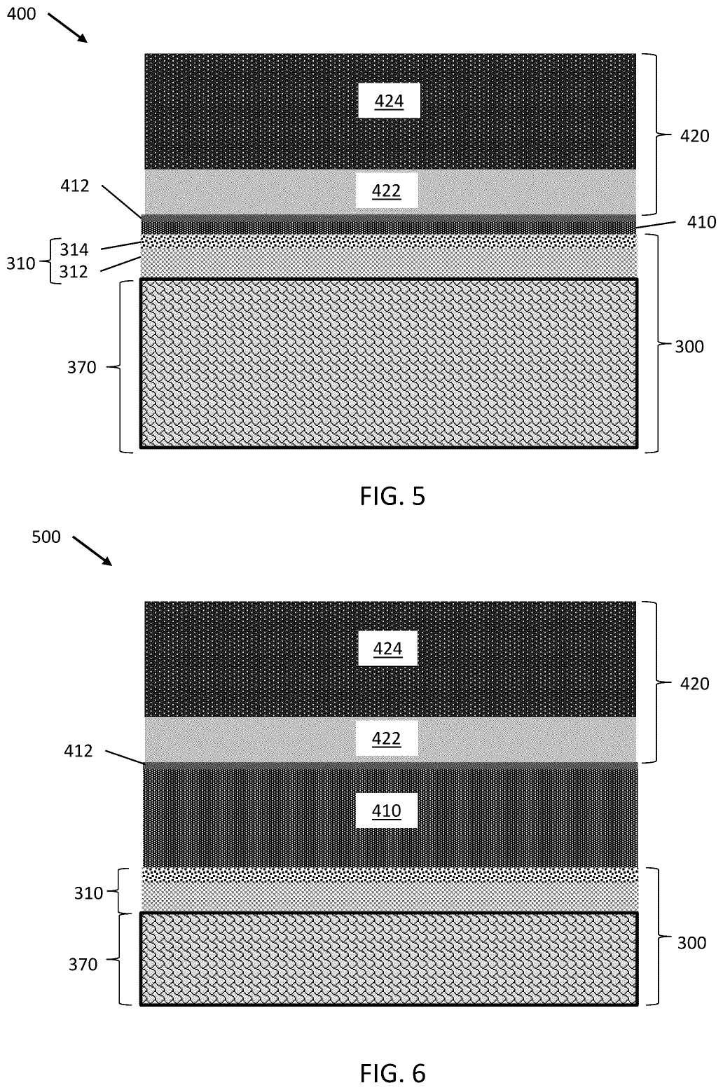

FIG. 6 is a cross-sectional view of a portion of a co-supported fuel cell 500, according to various embodiments of the present disclosure. The cell 500 may be similar to the cell 400 of FIG. 5. As such, only the differences therebetween will be discussed in detail.

Referring to FIG. 6, the cell 500 may include a thinner anode support 370 than that of the cell 400, and a thicker electrolyte layer 410 than that of the cell 400. In particular, the anode support 370 may have a thickness ranging from about 20 μm to about 100 μm, such as from about 25 μm to about 75 μm, or from about 40 μm to about 60 μm. The electrolyte layer 410 may have a thickness ranging from about 20 μm to about 80 μm, such as from about 30 μm to about 70 μm, or from about 40 μm to about 60 μm. The relatively thick electrolyte layer 410 may be self-supporting. As such, the thickness of the anode support 370 may be reduced, as compared to the anode support 370 of the cell 400, without compromising cell strength.

The electrochemical cells 400 and 500 may comprise solid oxide fuel cells or solid oxide electrolyzer cells. The cells 400 or 500 may be placed into a fuel cell or electrolyzer stack 50 shown in FIGS. 1A and 1B. The stack 50 may then be provided into a fuel cell or electrolyzer system. Alternatively, multiple stacks 50 may be arranged into a column by placing stacks on top of each other, and the column and/or multiple columns may then be provided into a fuel cell or electrolyzer system.

Fuel cell and electrolyzer systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrochemical cell, comprising:
an anode support comprising:
a mat comprising ceramic support fibers;
a cermet matrix comprising a nickel phase and a ceramic phase embedded in the mat;
an anode electrode disposed on the anode support;
an electrolyte layer disposed on the anode electrode; and
a cathode electrode disposed on the electrolyte layer.

2. The electrochemical cell of claim 1, wherein the ceramic fibers comprise yttria stabilized zirconia (YSZ) fibers.

3. The electrochemical cell of claim 2, wherein:
the ceramic fibers comprise three to four molar percent YSZ fibers or three to four molar percent YSZ blended with 2 to 5 mol percent alumina fibers; and
the cermet matrix comprises a nickel-YSZ cermet.

4. The electrochemical cell of claim 1, wherein the ceramic fibers comprise electrospun ceramic fibers.

5. The electrochemical cell of claim 4, wherein the ceramic fibers comprise randomly oriented ceramic fibers having an average diameter ranging from 250 nm to 2,000 nm.

6. The electrochemical cell of claim 1, wherein the electrochemical cell comprises a solid oxide fuel cell.

7. The electrochemical cell of claim 1, wherein the electrochemical cell comprises a solid oxide electrolyzer cell.

8. The electrochemical cell of claim 1, wherein the anode support is thicker than the electrolyte layer.

9. The electrochemical cell of claim 8, wherein the electrochemical cell comprises an anode supported cell.

10. The electrochemical cell of claim 1, wherein the electrochemical cell comprises an anode and electrolyte co-supported cell.

11. A method of forming an electrochemical cell, comprising:
providing a mat comprising electrospun support fibers;
embedding a cermet matrix material in the mat to form an anode support;
forming an anode electrode over the anode support;
forming a ceramic electrolyte over the anode electrode; and
forming a cathode electrode over the ceramic electrolyte.

12. The method of claim 11, wherein:
the embedding the cermet matrix material comprises embedding a green-state cermet matrix material;
the forming the anode electrode comprises forming a green-state cermet anode electrode; and
the forming the ceramic electrolyte comprises forming a green-state ceramic electrolyte.

13. The method of claim 12, further comprising firing the green-state cermet matrix material, the green-state cermet anode electrode, and the green-state ceramic electrolyte prior to the step of forming the cathode electrode over the ceramic electrolyte.

14. The method of claim 13, further comprising:
forming a mat of green-state hybrid organic-inorganic fibers using electrospinning; and
converting the mat of green-state hybrid organic-inorganic fibers to the mat comprising ceramic electrospun support fibers.

15. The method of claim 14, wherein:
the step of converting occurs during the step of firing; and
the step of firing forms a solid cermet matrix embedded in the mat of ceramic electrospun support fibers.

16. The method of claim 15, wherein:
the ceramic electrospun fibers comprise three to four molar percent yttria stabilized zirconia (YSZ) fibers or three to four molar percent YSZ blended with 2 to 5 mol percent alumina fibers;
the ceramic electrospun fibers comprise randomly oriented ceramic fibers having an average diameter ranging from 250 nm to 2,000 nm; and
the solid cermet matrix comprises a nickel-YSZ cermet.

17. The method of claim 14, wherein the embedding the cermet matrix material in the mat comprises depositing the green-state cermet matrix material over the mat using tape casting or slot die coating.

18. The method claim 11, wherein the matrix material further comprises a sacrificial pore forming material which is removed by heating to form pores in the cermet matrix material.

19. The method claim 11, wherein the electrochemical cell comprises a solid oxide fuel cell or a solid oxide electrolyzer cell.

20. The method claim 11, wherein the electrochemical cell comprises an anode supported cell or an anode and electrolyte co-supported cell.
